(19) United States
(12) Patent Application Publication
(10) Pub. No.: US 2004/0179476 A1
(43) Pub. Date: Sep. 16, 2004

(54) Apparatus and method for controlling a traffic switching operation based on a service class in an ethernet-based network

(76) Inventors: Sung-Ha Kim, Seoul (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/795,983

(22) Filed: Mar. 10, 2004

(30) Foreign Application Priority Data
Mar. 10, 2003 (KR) 2003-14684

(51) Int. Cl. H04L 1/00

(52) U.S. Cl. 370/230; 370/235; 370/360

(57) ABSTRACT

An apparatus and method for controlling a traffic switching operation based on a service class as provided in an Ethernet-based network while taking into account a class of service (CoS). In a switching control method for controlling traffic flow of an Ethernet frame in a process for transmitting the Ethernet frame received from at least one source node to at least one destination node, the Ethernet frame containing predetermined priority information designated on a service class-by-class basis is received from the source node. The received Ethernet frame is buffered in a data buffer classified by the class of service (CoS) corresponding to the priority information based on the service class. A size of data currently buffered in the data buffer is compared with a predetermined threshold value necessary for discriminating a traffic congestion state. When the size of data currently buffered in the data buffer is equal to or larger than the threshold value, a predetermined PAUSE frame containing a value of the CoS is generated. The PAUSE frame is transmitted to the source node through an input port having transferred the Ethernet frame.

### PRIORITY

This application claims priority to an application entitled “METHOD FOR CONTROLLING TRAFFIC SWITCHING OPERATION ON SERVICE CLASS-BY-CLASS BASIS IN ETHERNET-BASED NETWORK AND SWITCHING APPARATUS THEREFOR”, filed in the Korean Intellectual Property Office on Mar. 10, 2003 and assigned Serial No. 2003-14684, the contents of which are incorporated herein by reference.

### BACKGROUND OF THE INVENTION

1. Field of the Invention

The present invention relates to an apparatus and method for switching traffic on a network, and more particularly to an apparatus and method for controlling a traffic switching operation based on a service class in an Ethernet-based network, and a switching apparatus that can efficiently control the flow of an Ethernet frame while taking into account a class of service (CoS).

2. Description of the Related Art

Typically, a switching system on a communication network includes a network switch for transmitting data received from a plurality of source nodes to at least one desired node of a plurality of destination nodes.

A typical example of the switching system is a switching system based on the Ethernet described in Institute of Electrical and Electronics Engineers (IEEE) standard 802.3, which is incorporated herein by reference. In the Ethernet-based switching system, the flow of an Ethernet frame having a data format for Layer 2 is controlled by an Ethernet switch which is also known as a network switch.

FIG. 1A is a block diagram illustrating an Ethernet-based network to which a conventional Ethernet switch is coupled.

As shown in FIG. 1A, an Ethernet switch 100 is coupled between a plurality of source nodes 200 or 200₁, 200₂ through 200ₘ and a plurality of destination nodes 300 or 300₁, 300₂ through 300ₙ, and switches a data transmission path on the basis of a medium access control (MAC) address contained in the header information of an Ethernet frame. Furthermore, the Ethernet switch 100 typically performs bi-directional transmission. Locations of the source and destination nodes 200 and 300 are not fixed as shown in FIG. 1A. As an example, assuming that data is transmitted from the left side to the right side of the Ethernet switch 100, the source nodes 200 are located at the left side of the Ethernet switch 100 and the destination nodes 300 are located at the right side of the Ethernet switch 100 as shown in FIG. 1A.

The source node 200 is designated as an input node for transmitting an Ethernet frame to the Ethernet switch 100, and the destination node 300 is designated as an output node for receiving an Ethernet frame from the Ethernet switch 100. Moreover, it is assumed that the types of traffic to be switched by the Ethernet switch 100 are voice traffic and data traffic.

FIG. 1B is a block diagram illustrating an internal configuration of the conventional Ethernet switch 100 shown in FIG. 1A.

Referring to the Ethernet switch 100 shown in FIG. 1B, at least one 1^{st} network interface (NI) 110 comprising 110₁-110ₘ accesses source nodes 200 through the Ethernet, while at least one 2^{nd} NI 160 comprising 160₁-160ₙ accesses destination nodes 300 through the Ethernet. At least one 1^{st} interface controller (IC) 120 or 120₁-120ₘ is coupled between the source nodes 200 and a switching main module 130, while at least one 2^{nd} IC 150 comprising 150₁-150ₙ is coupled between the switching main module 130 and the destination nodes 300. The 1^{st} and 2^{nd} ICs 120 and 150 separate an Ethernet frame into header information and a payload or combine the header information and the payload, respectively. The switching main module 130 switches a transmission path of the Ethernet frame associated with voice and/or data traffic. A shared memory 140 temporarily stores header information units and payloads separated from Ethernet frames before the Ethernet frames received from the source nodes 200 are switched to the destination nodes 300. The 1^{st} and 2^{nd} ICs serve as input and output ports for transmitting and receiving the Ethernet frames and include well-known ingress and egress logics for data inputs and outputs, respectively.

The shared memory 140 is shared between all input and output ports, and configures a plurality of input and output queues according to preset input and output queuing schemes.

FIG. 2 is a block diagram illustrating a structure of the shared memory 140 shown in FIG. 1B. In FIG. 2, the shared memory 140 includes a data buffer 141 for buffering data and a plurality of registers 142 comprising REG#1, REG#2, REG#3, and REG#4. For example, it is assumed that the data buffer 141 buffers data in a unit of an Ethernet frame. Of course, a unit of stored data can be a conventional unit of a packet, or a unit of memory bits or bytes.

In the plurality of registers 142, the 1^{st} register (REG#1) registers a value a indicating a physical memory size of the data buffer 141. The 2^{nd} register (REG#2) registers a predetermined threshold value β necessary for determining whether a state of network traffic destined for the destination node 300 is a congestion state (hereinafter, referred to as a traffic congestion state). The 3^{rd} register (REG#3) registers a value indicative of an amount of data currently buffered in the data buffer 141. The 4^{th} register (REG#4) registers flag information indicative of the traffic congestion state when it is determined that the data buffer is in the traffic congestion state.

If the value registered in the 3^{rd} register (REG#3) indicating an amount of data buffered in the data buffer 141 is larger than the threshold value registered in the 2^{nd} register (REG#2), the switching main module 130 of the Ethernet switch 100 determines that the traffic congestion state has occurred and transmits a PAUSE frame to the source nodes 200, such that an operation for controlling traffic flow is performed. Here, “PAUSE” is one of the transmission control techniques defined in Institute of Electrical and Electronics Engineers (IEEE) standard 802.3. When the source nodes 200 receive the PAUSE frame, data transmission directed to the Ethernet switch 100 for a predetermined time, which is designated in the PAUSE frame, is stopped. That is, the PAUSE frame indicates a flow control frame that is transmitted from the Ethernet switch 100 to the source node 200 transmitting data.

FIG. 3 is a block diagram illustrating the data format of a conventional PAUSE frame.

In FIG. 3, an address of a node transmitting the PAUSE frame, that is, an address of the Ethernet switch 100 identified on the Ethernet, is recorded in a source address field P1 of the PAUSE frame. A unicast address indicative of a specific address or a multicast address (e.g., 02-80-C2-00-00-01₁₆) necessary for multicasting the PAUSE frame is recorded in a destination address field P2 of the PAUSE frame. Information (e.g., 88-08₁₆) indicative of a length/type of the PAUSE frame is recorded in a length/type field P3 of the PAUSE frame. PAUSE information (e.g. 00-01₁₆) is recorded in an OPCODE field P4 of the PAUSE frame. The PAUSE frame includes a field P5 containing at least one operand based on a corresponding OPCODE in an operand list associated with the OPCODE field P4. Where “PAUSE” is designated in the OPCODE field P4, the operand field P5 contains a pause time for which a PAUSE state is maintained in the source nodes 200 receiving the PAUSE frame. According to the conventional switching control apparatus and method, the Ethernet switch 100 determines that the traffic state is the traffic congestion state if an amount of data buffered in the data buffer 141 is more than the predetermined threshold value β whenever data is received from each source node 200, and transmits the PAUSE frame to all source nodes 200. The source nodes 200 receiving the PAUSE frame stop traffic transmission for a predetermined time. In this case, the source nodes 200 stop all traffic transmission operations irrespective of a type of traffic. Although the PAUSE frame is transmitted from the Ethernet switch 100 because voice traffic is sensitive to loss and delay in comparison with data traffic and has a higher priority, it is preferred that a continuous transmission operation for the voice traffic is ensured. However, because the source nodes 200 stop all traffic transmissions directed to corresponding input ports when the conventional technology transmits the PAUSE frame to the source nodes 200 coupled to arbitrary input ports irrespective of the type of traffic as described above, there is a problem in that an operation for reliably transmitting the voice traffic cannot be ensured.

### SUMMARY OF THE INVENTION

Therefore, the present invention has been made in view of the above problems, and it is one object of the present invention to provide a method for controlling a traffic switching operation based on the priority associated with a service class in an Ethernet-based network and a switching apparatus therefor that can efficiently control flow of an Ethernet frame while taking into account a class of service (CoS) according to a type of traffic.

It is another object of the present invention to provide a method for controlling a traffic switching operation based on a service class-in an Ethernet-based network and a switching apparatus therefor that can continuously provide transmission service in relation to a class of service (CoS) for traffic sensitive to delay such as voice traffic, while a PAUSE process is being performed because of traffic congestion. The method and apparatus classifying types of traffic and differentially applying the PAUSE process, such that a quality of service (QoS) for the voice traffic can be ensured.

In accordance with the first aspect of the present invention, the above and other objects can be substantially accomplished by the provision of a switching control method for controlling traffic flow of an Ethernet frame. The method comprising the steps of: receiving the Ethernet frame containing predetermined priority information based on a service class from a source node; buffering the received Ethernet frame in a data buffer classified by a class of service (CoS) corresponding to the priority information; comparing a size of data currently buffered in the data buffer with a predetermined threshold value; when the size of data currently buffered in the data buffer is equal to or larger than the threshold value, generating a PAUSE frame containing a value of the CoS; and transmitting the PAUSE frame to the source node.

In accordance with the second aspect of the present invention, the above and other objects can be substantially accomplished by the provision of a switching control method for controlling traffic flow of an Ethernet frame which is received from at least one source node is transmitted to at least one destination node. The method comprising the steps of: extracting a payload of an Ethernet frame to be transmitted to the destination node from a data buffer according to a corresponding CoS, the data buffer buffering the payload of the Ethernet frame based on a service class; comparing a size of data currently buffered in the data buffer with a predetermined threshold value; when the size of data currently buffered in the data buffer is smaller than the threshold value, generating an UNPAUSE frame having a value of the CoS and information indicating termination of a PAUSE state; and transmitting the UNPAUSE frame to the source node.

In accordance with the third aspect of the present invention, the above and other objects can be substantially by the provision of a switching control method for controlling traffic flow of an Ethernet frame which is received from at least one source node is transmitted to at least one destination node. The method comprising the steps of: allowing a predetermined network unit controlling the traffic flow to start an internal timer and to determine whether the pause time has expired; if the pause time has expired, comparing a size of data currently buffered in a data buffer based on a service class with a predetermined threshold value; when the size of data currently buffered in the data buffer is equal to or larger than the threshold value, re-generating a PAUSE frame containing a value of the CoS and information of the pause time; and transmitting the PAUSE frame to the source node.

In accordance with the fourth aspect of the present invention, the above and other objects can be substantially accomplished by the provision of a switching apparatus for controlling traffic flow of an Ethernet frame. The apparatus comprising: at least one input port for receiving the Ethernet frame from a source node; at least one output port for transmitting the Ethernet frame to a destination node; a shared memory shared between the input and output ports, the shared memory comprising: a plurality of data buffers based on service classes for classifying and storing Ethernet frames received through the at least one input port; and a plurality of registers for registering reference information to be used based on the service class; and a switching main module for determining a traffic congestion states on the basis of the reference information, generating a PAUSE frame to stop traffic flow of a corresponding class of service (CoS) when at least one of the data buffers is in the traffic congestion state, and transmitting the PAUSE frame to the source node.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a block diagram illustrating an Ethernet-based network to which a conventional Ethernet switch is coupled;

FIG. 1B is a block diagram illustrating an internal configuration of the conventional Ethernet switch shown in FIG. 1A;

FIG. 2 is a block diagram illustrating the structure of a shared memory shown in FIG. 1B;

FIG. 3 is a block diagram illustrating the data format of a conventional PAUSE frame;

FIG. 4 is a block diagram illustrating the internal configuration of an Ethernet switch 400 in accordance with an embodiment of the present invention;

FIG. 5 is a block diagram illustrating the structure of a shared memory included in the Ethernet switch 400 in accordance with an embodiment of the present invention;

FIG. 6 is a block diagram illustrating the data format of a PAUSE frame in accordance with an embodiment of the present invention;

FIG. 7 is a flow chart illustrating an initial setting procedure for registers shown in FIG. 5;

FIG. 8 is a flow chart illustrating a switching control process when traffic based on a class of service (CoS) is received in accordance with an embodiment of the present invention;

FIG. 9 is a flow chart illustrating a switching control process when an Ethernet frame based on a CoS is sent to a destination node in accordance with an embodiment of the present invention;

FIG. 10 is a flow chart illustrating an UNPAUSE process for terminating a PAUSE process in accordance with an embodiment of the present invention;

FIG. 11 is a flow chart illustrating a switching control process in a traffic normal state in accordance with an embodiment of the present invention; and

FIG. 12 is a flow chart illustrating a switching control process when a PAUSE process is performed in a traffic congestion state in accordance with an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals. In the following description, a detailed description of known functions and configurations incorporated herein will be omitted for conciseness.

The embodiments of the present invention relate to a switching control method and apparatus for transmitting Ethernet frames from a plurality of source nodes 200 to corresponding destination nodes 300. The embodiments of the present invention define a type of traffic as a class of service (CoS) indicative of a service priority. The embodiments of the present invention propose a new structure for a shared memory and a new data format for a PAUSE frame necessary for differentially applying a PAUSE process based on a service class. Furthermore, a switching main module in accordance with an embodiment of the present invention performs an operation for differentially applying the PAUSE process while taking into account the CoS.

In describing the embodiments of the present invention, the terminology in this specification is defined as follows. A “traffic congestion state” refers to a state in which a PAUSE process must be executed. A “traffic normal state” refers to a state in which traffic flow between input and output streams is proceeding normally without executing the PAUSE process.

Furthermore, “priority information” indicates a priority of service associated with traffic of an Ethernet frame as information contained in the Ethernet frame received from an Ethernet switch. In case of the Ethernet, Ethernet frames received by the Ethernet switch contain 3-bit priority information in an 802.1 Q priority field that is positioned in a Layer-2 media access control (MAC) header, respectively. According to the priority information, a maximum of 8 service classes can be classified. In accordance with an embodiment of the present invention, the Ethernet switch classifies received Ethernet frames corresponding to the priority information, differentiates the received Ethernet frames according to a predefined class of service (CoS) or differentiated service code point (DSCP), and maps a result of the classification and discrimination to a shared memory included in the Ethernet switch.

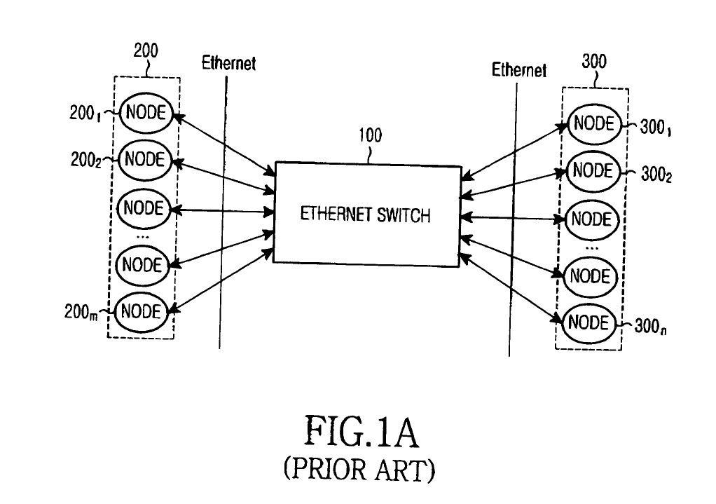

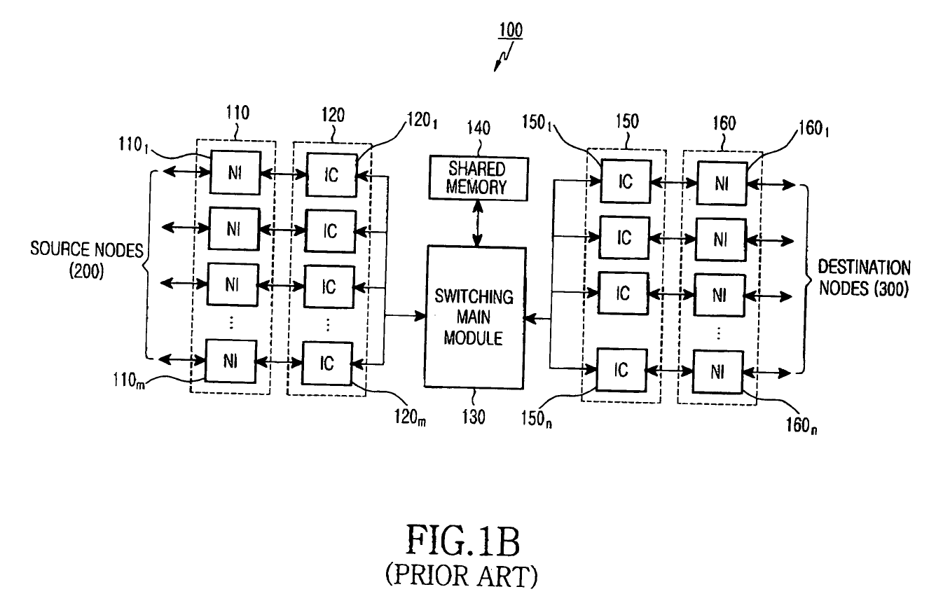

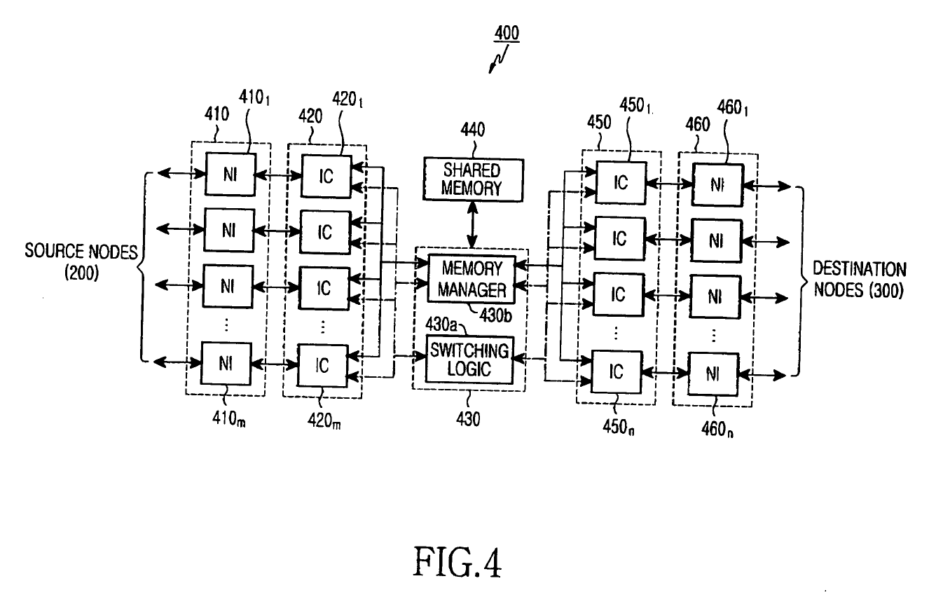

FIG. 4 is a block diagram illustrating the internal configuration of an Ethernet switch 400 in accordance with an embodiment of the present invention. In the Ethernet switch 400 shown in FIG. 4, 1^{st} network interfaces (NIs) 410 access the source nodes 200 through the Ethernet, while 2^{nd} second NIs 460 access the destination nodes 300 through the Ethernet. Furthermore, 1^{st} and 2^{nd} interface controllers (ICs) 420 and 450 coupled to the first and second NIs 410 and 460 provide input and output ports for traffic transportation. The 1^{st} and 2^{nd} ICs 420 and 450 separate/combine header information and a payload associated with a transmitted and received Ethernet frame, respectively. The functions performed by the 1^{st} and 2^{nd} NIs 410 and 460 and the 1^{st} and 2^{nd} ICs 420 and 450 are the same as those performed by the components shown in FIG. 1B.

A switching main module 430 shown in FIG. 4 includes a switching logic 430a and a memory manager 430b. The switching logic 430a is coupled between the 1st and 2nd ICs 420 and 450 and switches transmission paths of Ethernet frames between the source nodes 200 and the destination nodes 300 according to the header information of the Ethernet Frames. The memory manager 430b differentiates the received Ethernet frames using the priority information contained in the header information based on a predetermined service class, and stores the differentiated frames in the shared memory 440. Furthermore, the memory manager 430b determines the presence of a traffic congestion state, generates a predetermined PAUSE frame so that traffic flow can be maintained/stopped based on the service class according to a result of the determination, and transmits the generated PAUSE frame to the source node(s) 200 through an input port.

The switching logic 430a includes a mapping table (i.e., a Layer-2 table) in which information units of MAC addresses and input/output ports associated with the source and destination nodes 200 and 300 for the switching operation are mapped. Where a virtual local area network (VLAN) is employed, the switching logic 430a includes a VLAN table in which port information belonging to a corresponding VLAN is recorded. The switching logic 430a can employ an address resolution logic (ARU), etc.

The shared memory 440 is shared between all input and output ports, and configures a plurality of input and output queues according to preset input and output queuing schemes. It is assumed that the shared memory 140 stores data in a unit of an Ethernet frame. Of course, a unit of stored data can be a conventional unit of a packet, or a unit of memory bits or bytes.

In accordance with the embodiment of the present invention, the shared memory 440 is divided into one or more storage areas corresponding to the number of input ports. Each storage area based on an input port includes a plurality of data buffers for buffering payloads of the received Ethernet frames classified based on the service class, and a number of registers for registering predetermined reference information units to be used when the traffic congestion state is determined in accordance with the embodiment of the present invention.

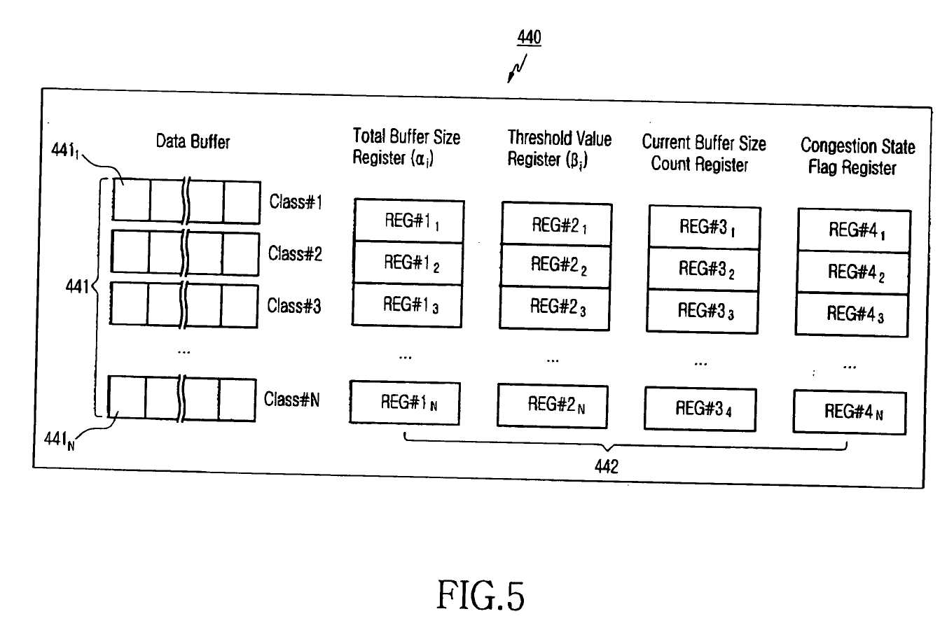

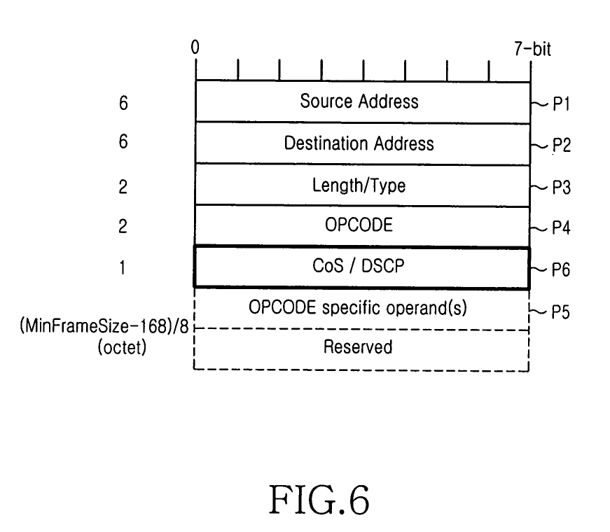

The reference information units contain buffer size information indicative of maximum physical storage capacities of the respective data buffers classified based on the service class; predetermined threshold information indicative of threshold storage capacities of the respective data buffers necessary for determining the traffic congestion state based on the service class; current data amount information indicative of amounts of data currently buffered in the data buffers based on the service class; and state flags for setting the presence of the traffic congestion state based on the service class. An internal structure of the shared memory 440 necessary for controlling traffic flow based on the service class and a data format of the PAUSE frame generated by the switching main module 430 in accordance with the embodiment of the present invention will be described in detail with reference to FIGS. 5 and 6.

FIG. 5 is a block diagram illustrating the structure of the shared memory 440 included in the Ethernet switch 400 in accordance with an embodiment of the present invention. For convenience of explanation, a storage area of the shared memory 440 assigned to one input/output port is shown in FIG. 5. Because the shared memory 440 is shared between a plurality of input and output ports, the structure shown in FIG. 5 actually includes a plurality of storage areas corresponding to the number of input/output ports.

Referring to FIG. 5, the shared memory 440 in accordance with the embodiment of the present invention includes a plurality of data buffers 441 or 441₁-441_{N} for buffering payloads of the received Ethernet frames classified by service classes (Class#l, Class#2, Class#3, up to Class#N); 1^{st} registers (REG#1ᵢ) each registering the maximum physical storage capacity size value αᵢ of one of the data buffers 441; 2^{nd} registers (REG#2ᵢ) each registering a threshold value βᵢ indicating threshold storage capacity of one of the data buffers 441 based on the service class; 3^{rd} registers (REG#3ᵢ) each registering information indicating an amount of data currently buffered in one of the data buffers 441 based on the service class; and 4^{th} registers (REG#4ᵢ) each registering a state flag indicating a traffic congestion state of one of the data buffers 441 based on the service class. Here, the subscript “i” denotes one of service class numbers 0-N. Thus, the 1^{st} to 4^{th} registers (REG#1ᵢ-REG#4ᵢ) in accordance with the embodiment of the present invention have a structure capable of registering the reference information units so that the traffic congestion state can be determined and confirmed based on the service class.

This embodiment of the present invention is structured so that the threshold value can be basically set for each of the data buffers 441 based on the service class. However, the threshold value can be set in two steps according to each input port, as well as each CoS. In this case, when an amount of data buffered in one of the data buffers 441 included in the shared memory 440 exceeds the threshold value set in any one of the CoS and the input port, the switching main module 430 transmits the PAUSE frame to the source node(s) 200 so that traffic flow associated with a corresponding CoS or input port can be stopped. FIG. 6 shows a data format of the PAUSE frame in accordance with an embodiment of the present invention.

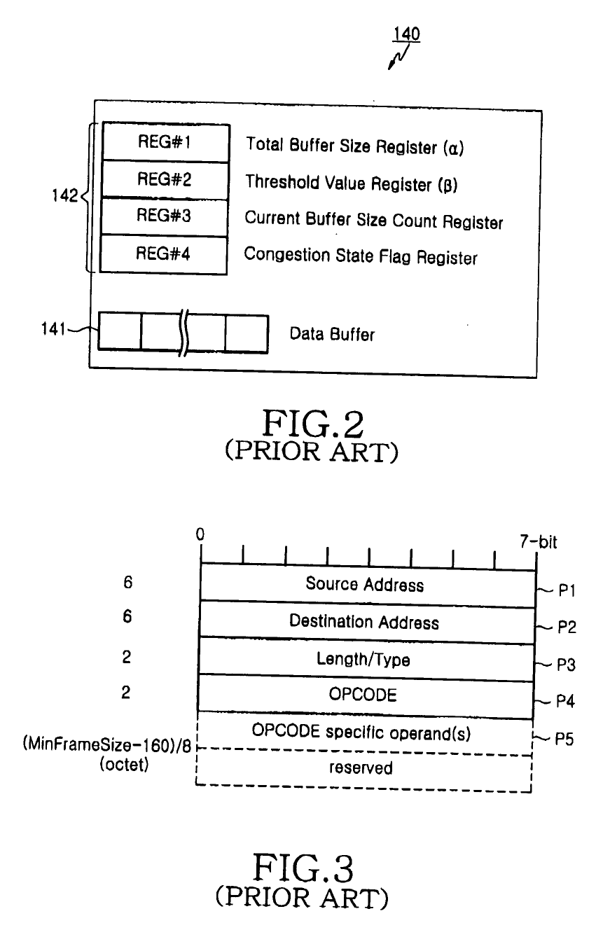

The PAUSE frame shown in FIG. 6 includes a source address field P1, a destination address field P2, a length/type field P3, an OPCODE field P4 and an operand field P5 identically with the PAUSE frame shown in FIG. 3 described above. The PAUSE frame shown in FIG. 6 further includes a class of service/differentiated service code point (CoS/DSCP) field P6. The operand field P5 contains information of a predetermined pause time for which the source node(s) 200 receiving the PAUSE frame can maintain a PAUSE state of traffic transmission associated with a CoS set as the priority information.

In accordance with the present invention, the source nodes 200 are configured such that they can receive the PAUSE frame from the Ethernet switch 400, respectively, and can confirm the priority information to stop a traffic transmission operation based on a corresponding CoS for the pause time. Therefore, when using the PAUSE frame, the Ethernet switch 400 can differentially stop only a traffic transmission operation corresponding to a specific CoS. For example, where a type of traffic received by the Ethernet switch 400 is voice and data traffic, the Ethernet switch 400 inserts priority information indicating a value of the corresponding CoS into the data traffic, such that a transmission service for the voice traffic having a relatively higher priority can be continuously provided even though the data traffic transmission operation is temporarily stopped. For convenience of explanation, the CoS is divided into a voice service class and a data service class in accordance with this embodiment of the present invention. The switching control method in accordance with the embodiment of the present invention will be described with reference to the voice and data service classes. When the CoS associated with the PAUSE frame is the data service class, the source nodes 200 transmitting the data traffic can stop a data transmission operation upon receiving the PAUSE frame. On the other hand, the source nodes 200 transmitting the voice traffic can continuously perform a voice traffic transmission operation because the PAUSE frame is not associated with their service classes.

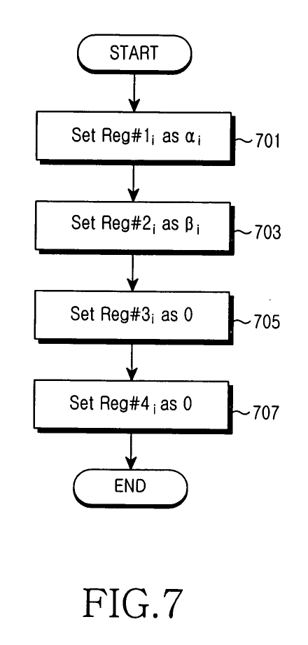

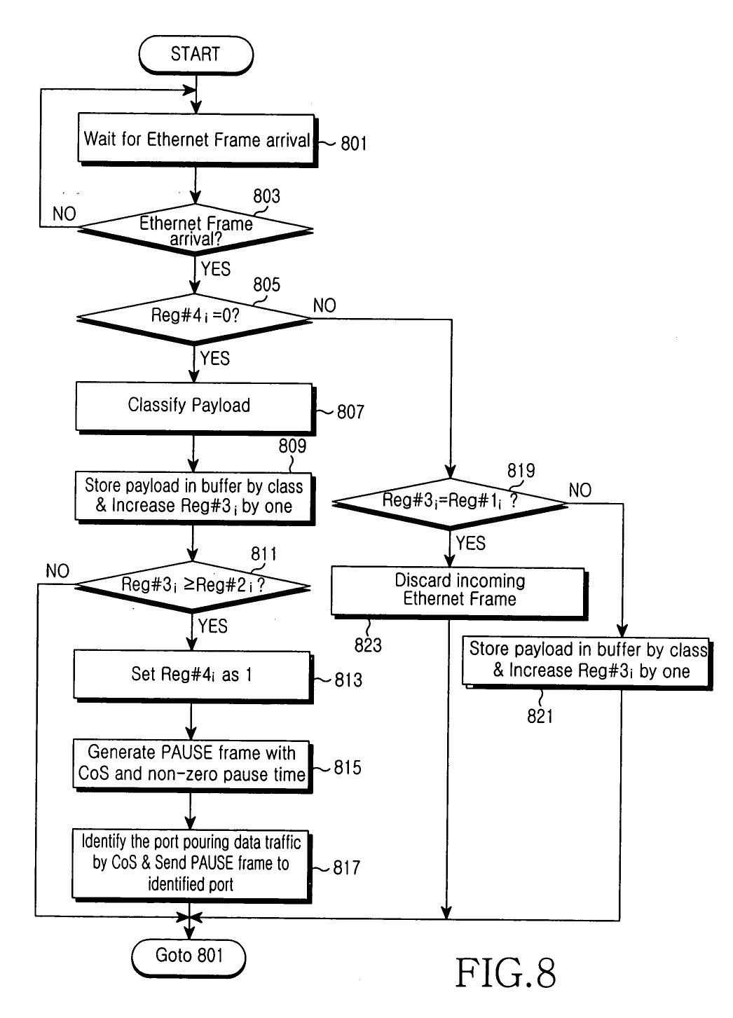

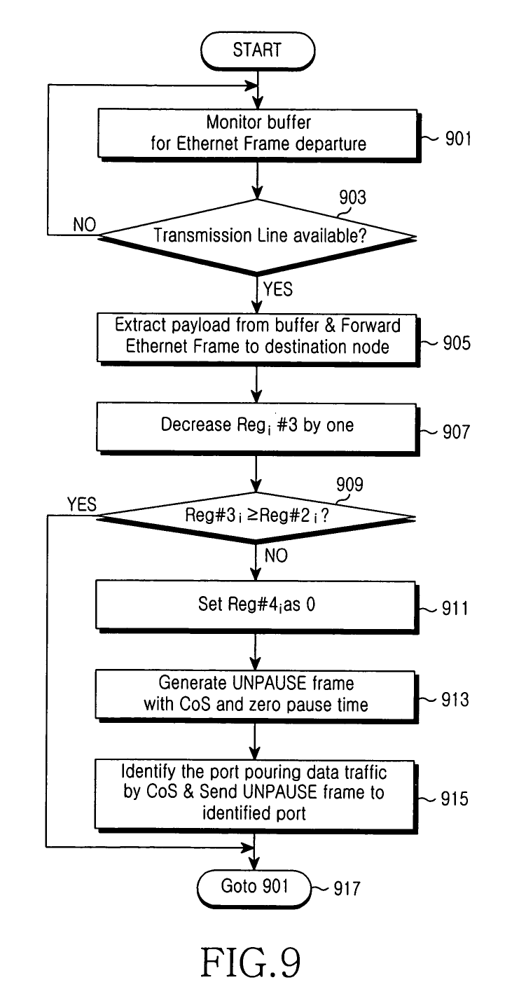

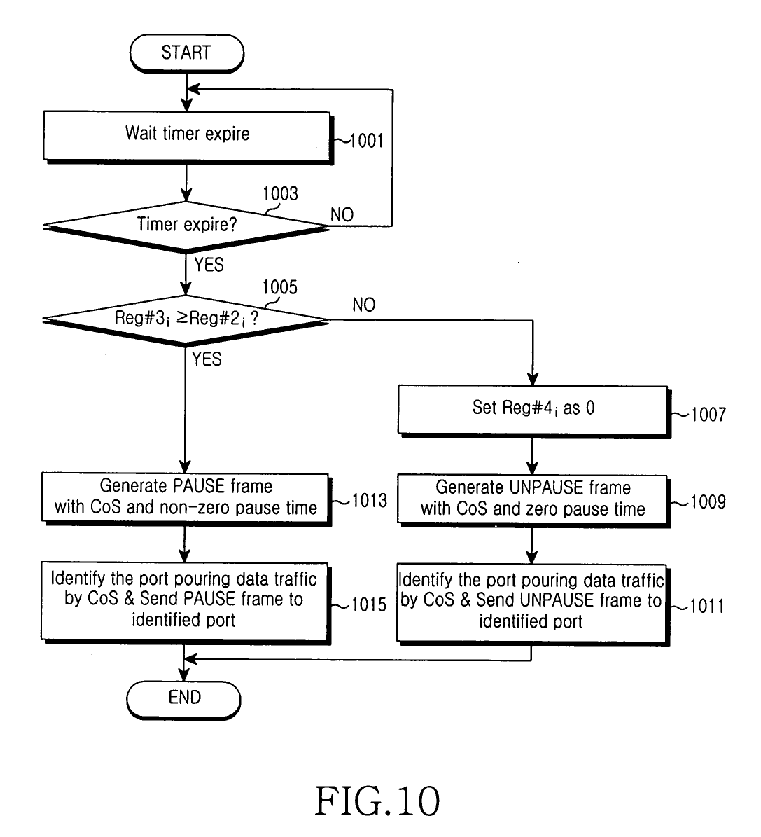

Now, the switching control method for traffic of a CoS based on the Ethernet in accordance with the embodiment of the present invention to which the above-described configuration is applied will be described with reference to FIGS. 7 and 10. The method in accordance with the present invention is divided into a process for initially setting reference information as shown in FIG. 7; a process for receiving traffic from the source nodes 200 on the service class-by-class basis as shown in FIG. 8; a process for transmitting traffic to the destination nodes 300 on the service class-by-class basis as shown in FIG. 9; and an UNPAUSE process for terminating a traffic PAUSE process on the service class-by-class basis as shown in FIG. 10. These processes will be described in detail. In addition, the method in accordance with the embodiment of the present invention can be applied to various Ethernet-based network switches capable of switching traffic based on the service class. For convenience of explanation, an example of using the Ethernet switch 400 shown in FIG. 4 will be described.

FIG. 7 is a flow chart illustrating a process for initially setting the 1^{st} to 4^{th} registers 442 shown in FIG. 5. Referring to FIG. 7, the network switch (e.g., the Ethernet switch 400 shown in FIG. 4) registers, in the 1^{st} registers (REG#1ᵢ), buffer size values αᵢ; of the data buffers 441 on the service class-by-class basis according to the storage area of the shared memory 440 based on the input/output port through the switching main module 430 when being initially started at step 701. The network switch registers storage capacity threshold values βᵢ; in the 2^{nd} registers (REG#2ᵢ) while taking into account the traffic congestion state based on the service class at step 703. The network switch sets values indicative of currently stored data capacities and state flags indicative of traffic congestion states associated with the data buffers to “0”, and registers the set values and state flags in the 3^{rd} and 4^{th} registers (REG#3ᵢ and REG#4ᵢ) at steps 705 and 707.

In this embodiment, the buffer size value αᵢ; and the threshold value βᵢ; use preset values. The state flag “0” refers to a “traffic normal state” indicating that traffic flow is normal, while the state flag “1” refers to a “traffic congestion state” indicating that traffic flow is congested. Furthermore, an operation for assigning memory areas of the data buffers 441 included in the shared memory 440 on an input/output port-by-port basis or service class basis basically uses preset fixed assignment amounts. Where the preset fixed assignment amounts are differently and dynamically assigned, periodically or randomly, according to network states or traffic types, the buffer size values αᵢ; and the threshold values βᵢ are set as different values whenever an assignment operation is performed, respectively. For convenience of explanation, it is assumed that the memory assignment uses the fixed assignment amounts.

FIG. 8 is a flow chart illustrating a switching control process when traffic based on a CoS is received in accordance with an embodiment of the present invention.

Referring to FIG. 8, a process for waiting to receive an Ethernet frame from an arbitrary one of the source nodes 200 is performed at steps 801 and 803. Here, the received Ethernet frame contains priority information. When the Ethernet frame is received at the step 803, the switching main module 430 confirms a state flag set in a 4^{th} register (REG#4ᵢ) of the shared memory 440 to determine whether a corresponding source node 200 is executing a traffic PAUSE process in response to a transmitted PAUSE frame at step 805.

When the switching main module 430 confirms the state flag “0” and the transmission PAUSE process is not executed in the corresponding source node 200, that is, when an operating state of the corresponding source node 200 is the traffic normal state, the switching main module 430 classifies a payload of the received Ethernet frame according to the priority information at step 807. Then, the switching main module 430 stores the classified payload in a corresponding data buffer 441 according to a corresponding CoS and increments current data amount information of the data buffer 441 by one unit (e.g., the frame unit) at step 809. Then, the switching main module 430 compares a current data amount registered in a 3^{rd} register (REG#3ᵢ) with a threshold value registered in a 2^{nd} register (REG#2ᵢ) at step 811.

If the current data amount registered in the 3^{rd} register (REG#3ᵢ) is less than the threshold value registered in the 2^{nd} register (REG#2ᵢ), the process returns to step 801 to perform the above-described steps. Otherwise, if the current data amount is equal to or more than the threshold value, the switching main module 430 determines that traffic is congested. The state flag of the 4^{th} register (REG#4ᵢ) is set as “1” indicative of the traffic congestion state at step 813. The switching main module 430 generates a PAUSE frame at step 815.

The PAUSE frame can contain non-zero pause time information or PAUSE start time information for a PAUSE process to be executed by the corresponding source nodes 200. The switching main module 430 can insert the value of a CoS of lower priority-based traffic or the value of a CoS having the largest effect on traffic congestion into priority information contained in the PAUSE frame, such that the corresponding service node 200 can execute a PAUSE process associated with traffic of a corresponding CoS.

The switching main module 430 transmits the generated PAUSE frame to the source nodes 200 coupled thereto through all input ports at step 817. Here, the PAUSE frame transmits traffic associated with the corresponding CoS to the source nodes 200 (e.g., nodes transmitting data traffic). On the other hand, when the state flag registered in the 4^{th} register (REG#4ᵢ) is determined to be “1”, and a traffic PAUSE process associated with the corresponding CoS is being executed, the switching main module 430 compares buffer size information of the 1^{st} register (REG#1ᵢ) with a current data amount of the 3^{rd} register (REG#3ᵢ) at step 819.

If the switching main module 430 determines that a space capable of storing a received packet remains after the PAUSE process has been executed, that is, if the buffer size information of the 1^{st} register (REG#1ᵢ) is different from the current data amount of the 3^{rd} register (REG#3ᵢ), as a result of the determination at the above step 819, it stores the received Ethernet frame in the data buffer 441 associated with a corresponding CoS after the PAUSE process has been executed, and increments a value of the 3^{rd} register (REG#3ᵢ) by one unit (e.g., frame unit) at step 821. Then, the switching main module 430 returns to step 801 and the above-described steps are repeated. When a spare storage space for the received Ethernet frame does not remain at step 819, that is, when the value of the 1^{st} register (REG#1ᵢ) is equal to the value of the 3^{rd} register (REG#3ᵢ), the switching main module 430 discards the received Ethernet frame at step 823 and the above-described steps are repeated.

FIG. 9 is a flow chart illustrating a switching control process when an Ethernet frame based on a CoS is transmitted to a corresponding destination node(s) 300 in accordance with an embodiment of the present invention.

The switching main module 430 of the Ethernet switch 400 monitors the respective data buffers 441 and determines whether data to be transmitted is present at step 901. Then, the switching main module 430 checks the operating states of the 1^{st} and 2^{nd} NIs 410 and 460 and the 1^{st} and 2^{nd} ICs 420 and 450, and determines whether lines, output ports, NIs, etc. for transmitting the Ethernet frame are available or in the normal state at step 903. If the above-described components are available or in the normal state as a result of the determination at the step 903, the switching main module 430 extracts a payload of the corresponding Ethernet frame from a corresponding data buffer 441, combines the extracted payload with header information destined for the destination node(s) 300 through the 2^{nd} NI(s) 450, and transmits the Ethernet frame at step 905.

The switching main module 430 decrements a value of the 3^{rd} register (REG#3ᵢ) indicating a currently stored data amount at step 907. Then, the switching main module 430 compares the value of the 3^{rd} register (REG#3ᵢ) with the value of the 2^{nd} register (REG#2ᵢ) and then determines whether a traffic congestion state of the corresponding data buffer 441 based on a corresponding CoS has been mitigated at step 909. At this point, if the value of the 3^{rd} register (REG#3ᵢ) is smaller than the value of the 2^{nd} register (REG#2ᵢ), the switching main module 430 determines that the traffic congestion state has been mitigated, and performs an UNPAUSE process for notification of the fact that the PAUSE process has been terminated. The switching main module 430 sets the value of the 4^{th} register (REG#4ᵢ) as “0” indicating the traffic normal state at step 911 and generates an UNPAUSE frame in which a pause time value is set to “0” at step 913. Here, the switching main module 430 inserts priority information of a corresponding CoS into the UNPAUSE frame. A data format of the PAUSE frame is the same as that of the UNPAUSE frame with the exception that the pause time value is set to “0” in the UNPAUSE frame.

That is, where information of a CoS contained in the UNPAUSE frame corresponds to data traffic, at least one of the source nodes 200 resumes corresponding data transmission after receiving the UNPAUSE frame. On the other hand, because the source node 200 transmitting voice traffic is not associated with its own CoS, the source node 200 can continuously transmit voice traffic. For example, it is assumed that the source nodes 200 consist of four source nodes Node 0, Node 1, Node 2 and Node 3, Node 0 and Node 1 transmit voice traffic, and Node 2 and Node 3 transmit data traffic. When the PAUSE frame is transmitted, the switching main module 430 inserts priority information indicating a number/symbol of a corresponding CoS associated with the Node 2 and Node 3 into the CoS field P6. Node 2 and Node 3 of the four source nodes 200 receiving the priority information recognize that traffic transmission of the corresponding CoS destined for the Ethernet switch 400 must be stopped.

At step 915, the switching main module 430 transmits the UNPAUSE frame to the input port receiving traffic of the corresponding CoS, sets the pause time to “0”, transmits the UNPAUSE frame having the value of an arbitrary CoS to the source node 200 coupled to the input port, and performs an UNPAUSE process for corresponding PAUSE traffic. Then, the switching main module 430 returns to step 901 and repeats the above-described steps.

In accordance with this embodiment, the source node 200 receiving the PAUSE frame stops traffic transmission of a corresponding CoS for a pause time designated in the PAUSE frame, and resumes the traffic transmission after the pause time. However, after the PAUSE frame is transmitted to the source node 200 according to the process shown in FIG. 9, the pause time is counted by an internal timer (not shown) provided in the Ethernet switch 400 and the counted pause time expires, the Ethernet switch 400 can perform an UNPAUSE process by transmitting, to the source node 300, an UNPAUSE frame in which the pause time is set as “0”. In this case, the UNPAUSE frame can be transmitted to the source node 200 when the value of the 3^{rd} register (REG#3ᵢ) is smaller than the value of the 2^{nd} register (REG#2ᵢ) indicating the threshold value, the traffic congestion state has been mitigated, and the pause time counted by the internal timer has expired as shown in FIG. 9. Alternatively, it is preferred that the PAUSE frame can be transmitted according to the traffic congestion state although the pause time counted by the internal timer expires.

FIG. 10 is a flow chart illustrating an UNPAUSE process for terminating the PAUSE process in accordance with an embodiment of the present invention. In the UNPAUSE process shown in FIG. 10, it is assumed that the switching main module 430 counts a predetermined pause time designated in the PAUSE frame using the internal timer (not shown) after the PAUSE frame is transmitted to the service node 200. Even though the internal timer has expired, the UNPAUSE process shown in FIG. 10 compares register values and determines whether the traffic congestion state has been mitigated according to a result of the comparison.

Referring to FIG. 10, the switching main module 430 having previously transmitted the PAUSE frame determines whether or not the internal timer has expired at steps 1001 and 1003. If the internal timer has expired, the switching main module 430 compares the value of the data amount currently registered in the 3^{rd} register (REG#3ᵢ) with the threshold value registered in the 2^{nd} register (REG#2ᵢ) at step 1005. The switching main module 430 determines that the traffic congestion state has been mitigated if the value registered in the 3^{rd} register (REG#3ᵢ) is smaller than the threshold value registered in the 2^{nd} register (REG#2ᵢ), sets the state flag of a corresponding CoS as “0”, and performs an UNPAUSE process using the CoS for transmitting an UNPAUSE frame in which the pause time is set as “0” at steps 1007 to 1011.

On the other hand, the switching main module 430 determines that the traffic congestion state has not been mitigated if the value registered in the 3^{rd} register (REG#3ᵢ) is equal to or larger than the threshold value registered in the 2^{nd} register (REG#2ᵢ) at step 1005. Then, the switching main module 430 sets the pause time as a non-zero value, generates a PAUSE frame containing priority information of a CoS associated with the PAUSE process, and transmits the generated PAUSE frame to an input port at steps 1013 and 1015.

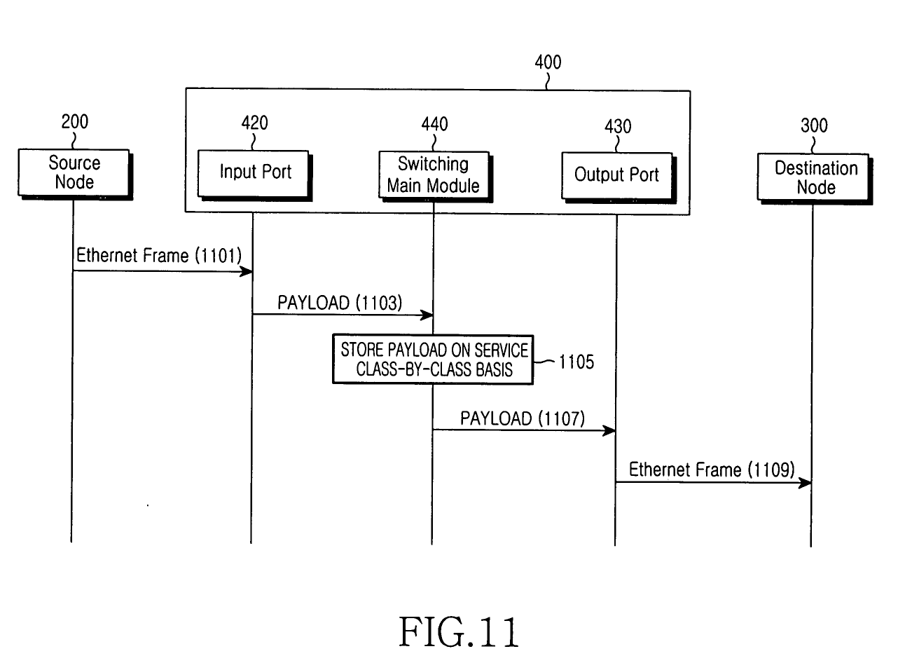

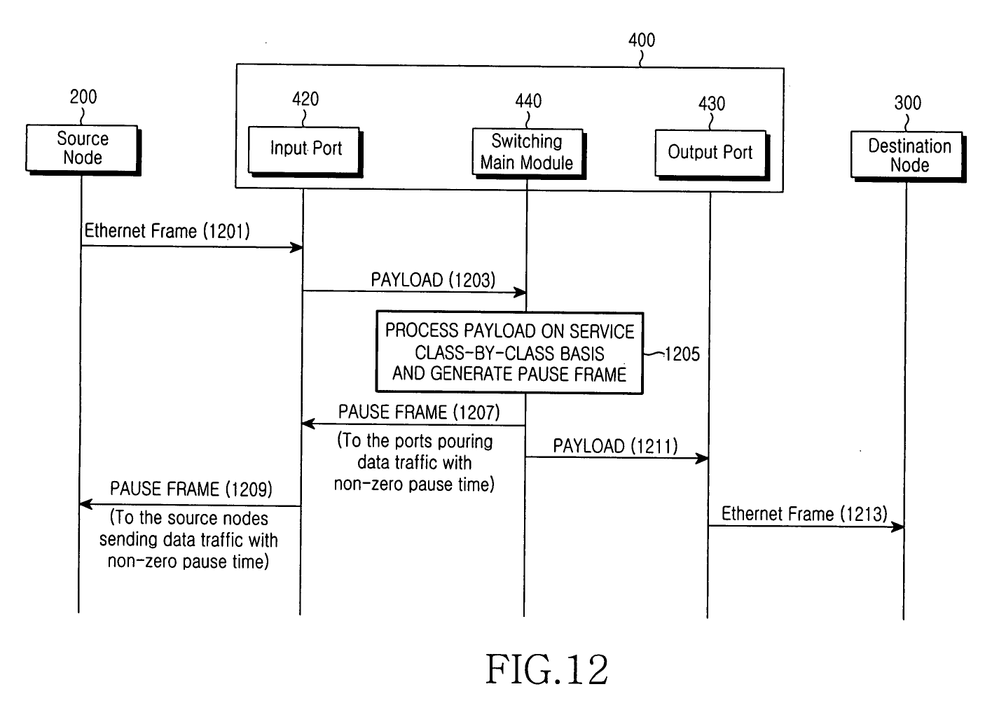

A switching control process for an Ethernet frame in the traffic normal state and the traffic congestion state will now be described with reference to FIGS. 11 and 12. As input and output ports are correspondingly coupled to the 1^{st} and 2^{nd} ICs 420 and 440, the input and output ports are designated by the same reference numerals 420 and 440 as in the 1^{st} and 2^{nd} ICs shown in FIG. 4.

FIG. 11 is a flow chart illustrating a switching control process in the traffic normal state in accordance with an embodiment of the present invention.

Referring to FIG. 11, when an Ethernet frame is received from an arbitrary source node 200 at step 1101, the Ethernet frame is separated into header information and a payload, and the header information and payload are transmitted to the switching main module 430 through the input port 420 at step 1103. The switching main module 430 classifies the payload according to priority information contained in the received header information and stores the classified payload in a data buffer 441 of the shared memory 440 based on a service class at step 1105. Then, if the switching main module 440 determines the traffic congestion state and a value of a data amount currently buffered in the data buffer 441 is smaller than a preset threshold value at step 1107, it transmits the Ethernet frame to a corresponding destination node 300 through the output port 430 coupled thereto at steps 1107 and 1109.

FIG. 12 is a flow chart illustrating a switching control process when a PAUSE process is performed in a traffic congestion state in accordance with an embodiment of the present invention.

Referring to FIG. 12, steps 1201 and 1203 are performed equally with the above steps 1101 and 1103 shown in FIG. 11. At step 1205, the switching main module 430 classifies the payload according to priority information contained in the received header information and stores the classified payload in a data buffer 441 of the shared memory 440 based on a service class. Furthermore, if it is determined that a value of a data amount currently buffered in the data buffer 441 is equal to or larger than a preset threshold value and a traffic congestion state is predicted, the switching main module 430 generates a PAUSE frame containing a non-zero pause time and priority information indicative of a corresponding CoS.

Here, the PAUSE frame contains a value of a CoS having a lower priority (e.g., data traffic). Furthermore, the switching main module 430 transmits the PAUSE frame to an input port 420 of a corresponding source node 200 at step 1207. The input port 420 transmits the PAUSE frame to the corresponding source node 200 at step 1209. As a result, nodes receiving the PAUSE frame stop traffic (e.g., data traffic) corresponding to a value of a corresponding CoS contained in the PAUSE frame for a pause time. In accordance with the embodiment of the present invention, a service for providing higher priority traffic (e.g., voice traffic) can be continuously supported. Furthermore, the switching main module 430 reads a classified and stored payload from the data buffer 441 and transmits an Ethernet frame to a corresponding destination node 300 through the output port 430 at steps 1211 and 1213. According to the above-described processes, traffic congestion within the switch can be mitigated, and simultaneously quality of service (QoS) for higher priority traffic can be ensured.

As apparent from the above description, the embodiments of the present invention can control a traffic switching operation using a differentiated PAUSE technique according to the type of traffic.

The embodiments of the present invention can continuously support voice traffic requiring reliable transmission also in a traffic congestion state by differentially performing a PAUSE process according to a class of service (CoS). Furthermore, the embodiments of the present invention can mitigate traffic congestion by performing the PAUSE process for lower priority traffic such as general data traffic.

Although the embodiments of the present invention have been disclosed for illustrative purposes, those skilled in the art will appreciate that various modifications, additions and substitutions are possible, without departing from the scope of the invention. Therefore, the present invention is not limited to the above-described embodiments and drawings.

What is claimed is:

1. A switching control method for controlling traffic flow of an Ethernet frame comprising the steps of:
receiving the Ethernet frame containing predetermined priority information based on a service class from a source node;
buffering the received Ethernet frame in a data buffer classified by a class of service (CoS) corresponding to the priority information;
comparing a size of data currently buffered in the data buffer with a predetermined threshold value;
when the size of data currently buffered in the data buffer is equal to or larger than the threshold value, generating a PAUSE frame containing a value of the CoS; and
transmitting the PAUSE frame to the source node.

2. The switching control method as set forth in claim 1, wherein the predetermined threshold value is necessary for determining a traffic congestion state.

3. The switching control method as set forth in claim 1, further comprising the steps of:
when a state of the data buffer is the traffic congestion state as a result of the comparison using the threshold value, determining whether or not a spare space remains in the data buffer; and
if a spare space remains in the data buffer as a result of the determination, storing the received Ethernet frame in the data buffer according to the priority information

4. The switching control method as set forth in claim 3, further comprising the step of:
if a spare space does not remain in the data buffer as a result of the determination, discarding the received Ethernet frame.

5. The switching control method as set forth in claim 1, further comprising the step of:
when the size of data currently buffered in the data buffer is equal to or larger than the threshold value, setting a predetermined state flag indicative of a traffic congestion state.

6. The switching control method as set forth in claim 1, wherein the PAUSE frame further includes information of a predetermined pause time for which traffic transmission of a corresponding CoS is stopped.

7. The switching control method as set forth in claim 1, wherein the source node receiving the PAUSE frame stops transmission of an Ethernet frame having a priority of a corresponding CoS for a predetermined time.

8. The switching control method as set forth in claim 1, wherein information of the CoS is included in the PAUSE frame and header information of the Ethernet frame.

9. The switching control method as set forth in claim 1, wherein a priority of the CoS associated with voice traffic is higher than that associated with data traffic.

10. A switching control method for controlling traffic flow of an Ethernet frame which is received from at least one source node is transmitted to at least one destination node, comprising the steps of:
extracting a payload of an Ethernet frame to be transmitted to the destination node from a data buffer according to a corresponding CoS, the data buffer buffering the payload of the Ethernet frame based on a service class;
comparing a size of data currently buffered in the data buffer with a predetermined threshold value;
when the size of data currently buffered in the data buffer is smaller than the threshold value, generating an UNPAUSE frame having a value of the CoS and information indicating termination of a PAUSE state; and
transmitting the UNPAUSE frame to the source node.

11. The switching control method as set forth in claim 10, wherein the predetermined threshold value is necessary for determining a traffic congestion state.

12. The switching control method as set forth in claim 10, further comprising the step of:
allowing the source node receiving the UNPAUSE frame to terminate the PAUSE state of traffic belonging to a corresponding CoS.

13. The switching control method as set forth in claim 10, further comprising the step of:
when the UNPAUSE frame is transmitted, setting predetermined flag information indicative of a traffic congestion state as a value of a traffic normal state.

14. The switching control method as set forth in claim 10, wherein the information indicative of the termination of the PAUSE state is time information set as a zero pause time.

15. A switching control method for controlling traffic flow of an Ethernet frame which is received from at least one source node is transmitted to at least one destination node, comprising the steps of:
allowing a predetermined network unit controlling the traffic flow to start an internal timer and to determine whether the pause time has expired;
if the pause time has expired, comparing a size of data currently buffered in a data buffer based on a service class with a predetermined threshold value;
when the size of data currently buffered in the data buffer is equal to or larger than the threshold value, re-generating a PAUSE frame containing a value of the CoS and information of the pause time; and
transmitting the PAUSE frame to the source node.

16. The switching control method as set forth in claim 15, wherein the predetermined threshold value is necessary for determining a traffic congestion state.

17. The switching control method as set forth in claim 15, wherein the source node re-stops transmission of the Ethernet frame for a time included in the pause time information.

18. The switching control method as set forth in claim 15, further comprising the step of:
when the size of data currently buffered in the data buffer is smaller than the threshold value, generating an UNPAUSE frame in which the pause time for a corresponding CoS is set as “0” and transmitting the UNPAUSE frame to the input port coupled to the source node.

19. The switching control method as set forth in claim 18, wherein the UNPAUSE frame is generated in the same data format as a data format of the PAUSE frame.

20. A switching apparatus for controlling traffic flow of an Ethernet frame comprising:
at least one input port for receiving the Ethernet frame from a source node;
at least one output port for transmitting the Ethernet frame to a destination node;
a shared memory shared between the input and output ports, the shared memory comprising:
a plurality of data buffers based on service classes for classifying and storing Ethernet frames received through the at least one input port; and
a plurality of registers for registering reference information to be used based on the service class; and
a switching main module for determining a traffic congestion states on the basis of the reference information, generating a PAUSE frame to stop traffic flow of a corresponding class of service (CoS) when at least one of the data buffers is in the traffic congestion state, and transmitting the PAUSE frame to the source node.

21. The switching apparatus as set forth in claim 20, wherein the switching main module comprises:
a switching logic for switching a transmission path of the Ethernet frame between the source node and the destination node; and
a memory manager for classifying and storing the Ethernet frame received through the input port, generating the PAUSE frame, and transmitting the generated PAUSE frame to the source node.

22. The switching apparatus as set forth in claim 20, wherein the PAUSE frame contains information of a predetermined pause time for which traffic transmission of a corresponding CoS is stopped.

23. The switching apparatus as set forth in claim 20, wherein the switching main module further generates a UNPAUSE frame to resume traffic flow of a corresponding CoS when it is determined that the traffic congestion state in each of the data buffers is switched to a normal state on the basis of the reference information, and transmits the generated UNPAUSE frame to the input port coupled to the source node.

24. The switching apparatus as set forth in claim 20, wherein the switching main module further generates a UNPAUSE frame corresponding to the CoS when a pause time has expired and the size of data currently buffered in the data buffer is smaller than a threshold value.

25. The switching apparatus as set forth in claim 20, wherein the switching main module further re-generates a PAUSE frame corresponding to the CoS when a pause time has expired and the size of data currently buffered in the data buffer is equal or larger than a threshold value.

26. The switching apparatus as set forth in claim 20, wherein the registers comprises:
first registers for registering physical size information of the data buffers;
second registers for registering predetermined threshold values necessary for determining the traffic congestion states of the data buffers;
third registers for registering size information of data currently buffered in the data buffers; and
fourth registers for registering predetermined state flags indicative of the traffic congestion states,
wherein the information registered in the first to fourth registers is used as the reference information.

27. The switching apparatus as set forth in claim 20, wherein the reference information comprises:
buffer size information indicative of maximum physical storage capacities of the data buffers;
predetermined threshold information indicative of threshold storage capacities of the data buffers necessary for determining the traffic congestion states based on the service class;
current data amount information indicative of amounts of data currently buffered in the data buffers based on the service class; and
state flags for setting the traffic congestion states based on the service class.

28. The switching apparatus as set forth in claim 27, wherein the switching main module determines that one of the data buffers is in the traffic congestion state when an amount of data currently buffered in the data buffer based on a corresponding CoS is equal to or more than a threshold value.
